(19) United States
(12) Patent Application Publication
(10) Pub. No.: US 2016/0239256 A1
(43) Pub. Date: Aug. 18, 2016

(54) Electronic Apparatus and Operation Mode Enabling Method Thereof

(71) Applicant: AVerMedia Technologies, Inc., New Taipei City (TW)

(72) Inventors: Chun-Tang Hsu, New Taipei City (TW); Shou-Kuo Tai, New Taipei City (TW)

(21) Appl. No.: 15/016,518

(22) Filed: Feb. 5, 2016

(30) Foreign Application Priority Data
Feb. 13, 2015 (TW) 104104963

(51) Int. Cl. G06F 3/16; G06F 3/0488; G06F 3/0482

(52) U.S. Cl. CPC G06F 3/165; G06F 3/0482; G06F 3/0488

(57) ABSTRACT

An electronic apparatus comprising an output unit, an input unit, and a processor is provided. The output unit generates an output. The input unit generates at least one input signal according to an object. The processor electrically connected to the output unit and the input unit receives the at least one input signal and adjusts the output of the output unit to a predetermined state according to the at least one input signal. The processor enables a predetermined operation mode of the electronic apparatus when receiving the at least one input signal again in the predetermined state.

This application claims the benefit of priority based on Taiwan Patent Application No 104104963, filed on Feb. 13, 2015, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to an electronic apparatus and an operation mode enabling method of the electronic apparatus. In particularly, the present invention relates to an electronic apparatus enabling a predetermined operation mode when receiving a sliding touch or a press of an object in a predetermined state.

2. Descriptions of the Related Art

As portable electronic devices become more compact, and the number of functions performed by a given device increase, it has become a significant challenge to design a user interface that allows users to easily interact with a multifunction device. This challenge is particular significant for portable devices, which have smaller screens. The user interface is the gateway through which users receive not only content but also responses to user actions or behaviors, including user attempts to access a device's features, tools, and functions. Some portable communication devices have resorted to adding more buttons, increasing the density of buttons, overloading the functions of buttons, or using complex menu systems to allow a user to access, store and manipulate data.

These complex user interfaces often result in complicated key sequences and menu hierarchies that must be memorized by the user. When coupled with the time consuming requirement to memorize multiple key sequences and menu hierarchies, and the difficulty in activating a desired button, such inflexibility is frustrating to most users. The displayed information may not be distinguished accurately, the user's attention may be directed towards wrong information, and users may be overloaded with extraneous information.

It is therefore an important subject to provide an electronic apparatus enabling a predetermined operation mode that conveys the information content quickly and accurately.

### SUMMARY OF THE INVENTION

In view of the foregoing, the present disclosure is to provide embedded power supplying device, which is using in a desk to overcome the deficiencies of the prior art.

To achieve the above, an electronic apparatus including an output unit, an input unit and a processor is provided. The output unit generates an output. The input unit generates an input signal according to an object. The processor, electrically connected to the input unit and the output unit, receives the input signal and adjusts the output of the output unit to a predetermined state according to the input signal. When receiving the said input signal again in the predetermined state, the processor enables a predetermined operation mode of the electronic apparatus.

In one aspect of the present disclosure, an operation mode enabling method of an electronic apparatus is provided. The electronic apparatus includes an input unit, a processor and an output unit. The operation mode enabling method includes the steps of: generating an output by the output unit; generating an input signal by the input unit according to an object; receiving the input signal by the processor; adjusting the output of the output unit to a predetermined state according to the at least one input signal; identifying if the processor receives the at least one input signal again in the predetermined state by the processor; and enabling a predetermined operation mode of the electronic apparatus by the processor when the processor receives the at least one input signal again in the predetermined state.

As mentioned above, once the processor receives the said input signal again in the predetermined state, the electronic apparatus and the related method of the invention can enable a predetermined operation mode of the electronic apparatus. Thus, the above deficiencies and other problems associated with the complicated key sequences and menu hierarchies for portable devices are reduced or eliminated by the disclosed electronic apparatus. The displayed information can be distinguished accurately, and users are not overloaded with extraneous information.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a schematic diagram showing an electronic apparatus according to a first embodiment of the present invention.

FIG. 2 is a schematic block diagram showing the electronic apparatus according to the first embodiment of the present invention.

FIG. 3 illustrates the electronic apparatus displaying an electronic document according to the first embodiment of the present invention.

FIG. 4 illustrates the electronic apparatus displaying another portion of the electronic document according to the first embodiment of the present invention.

FIG. 5 illustrates the electronic apparatus displaying an edge of the electronic document according to the first embodiment of the present invention.

FIG. 6 illustrates the electronic apparatus displaying the electronic document and an operation menu according to the first embodiment of the present invention.

FIG. 7 illustrates the electronic apparatus displaying a volume adjustment box according to the first embodiment of the present invention.

FIG. 8 illustrates the electronic apparatus playing a limit of volume according to the first embodiment of the present invention.

FIG. 9 is a flow chart illustrating an operation mode enabling method according to a second embodiment of the present invention.

FIG. 10 is a flow chart illustrating an operation mode enabling method according to a third embodiment of the present invention.

### DESCRIPTION OF THE PREFERRED EMBODIMENT

Reference will now be made to the drawings to describe various inventive embodiments of the present disclosure in detail, wherein like numerals refer to like elements throughout.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

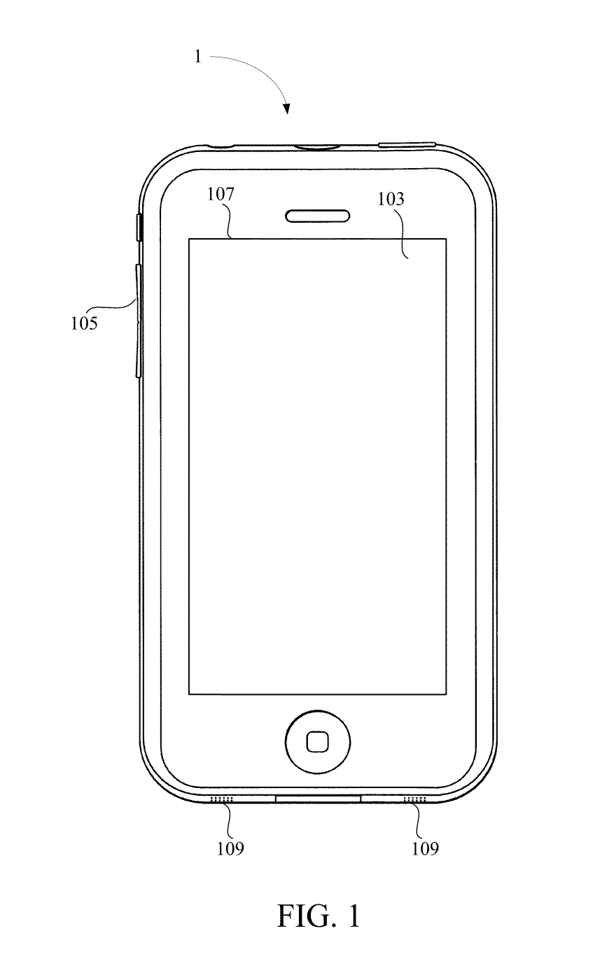

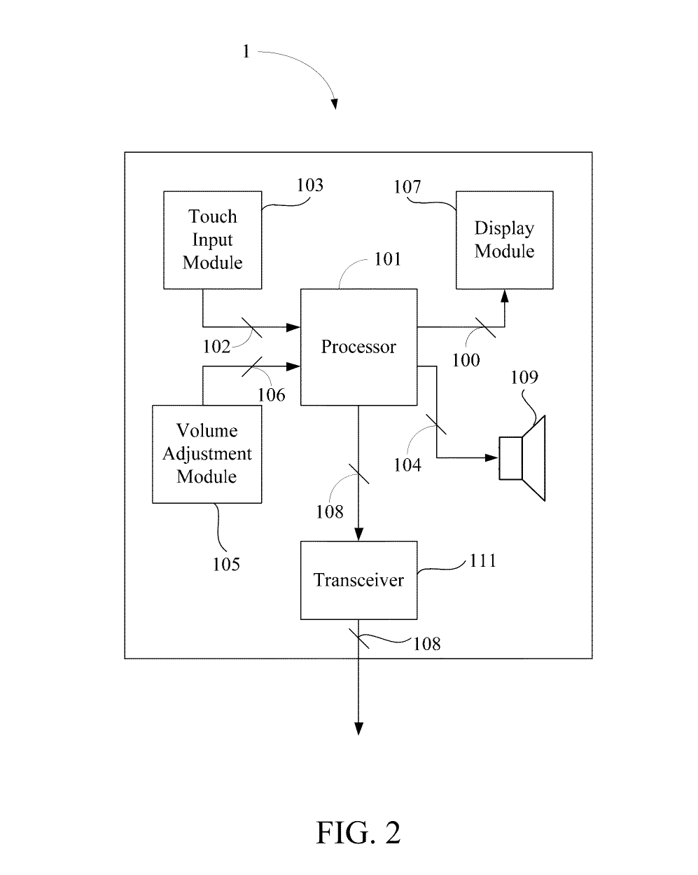

An electronic apparatus 1 of the present invention can be a smart phone, a personal digital assistant (PDA) or a laptop. As shown in FIG. 1 and FIG. 2, the electronic apparatus 1 is a smart phone in the first embodiment. The electronic apparatus 1 includes a processor 101, a touch input module 103, a volume adjustment module 105, a display module 107, a sound module 109 and a transceiver 111. The processor 101 is electrically connected to the touch input module 103, the volume adjustment module 105, the display module 107, the sound module 109 and the transceiver 111. The touch input module 103 and the volume adjustment module 105 are both input units of the electronic apparatus 1. The display module 107 and the sound module 109 are both output units of the electronic apparatus 1.

In this embodiment, the touch input module 103 and the display module 107 are separately manufactured, and are assembled together in an out-cell touch panel. The touch input module 103 and the display module 107 are not limited by this embodiment. In other embodiments, the touch input module 103 and the display module 107 may be integrally manufactured in an in-cell touch panel.

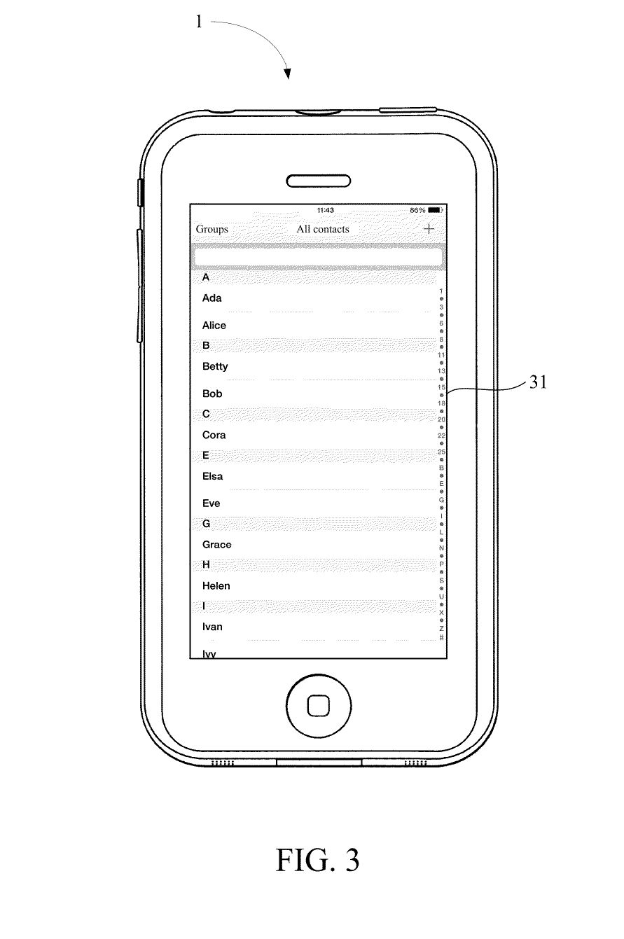

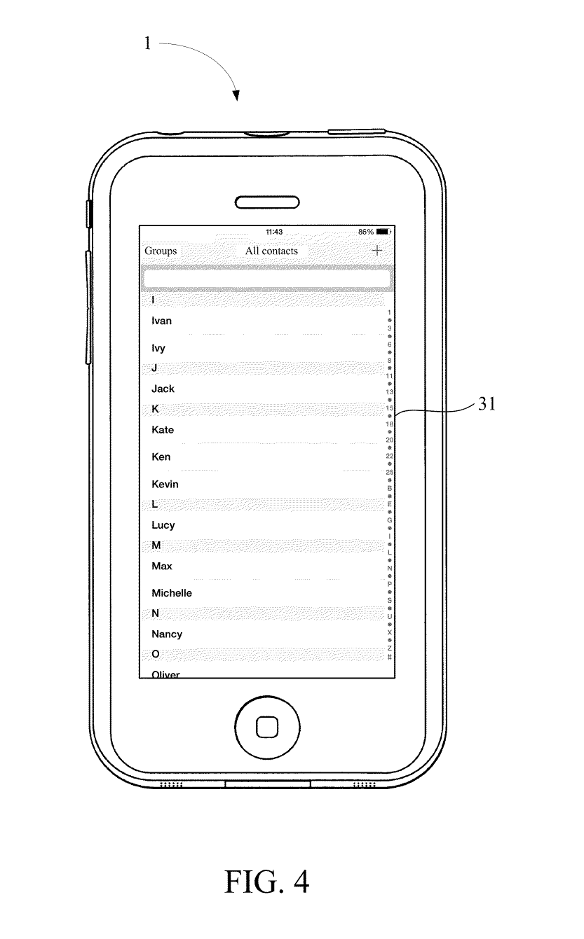

Referring to FIG. 1 through FIG. 6, an operation mode enabling method of the electronic apparatus 1 is provided. In operation of the electronic apparatus 1, the processor 101 transmits a video signal 100 to the display module 107, such that the display module 107 displays an image of an electronic document 31 shown in FIG. 3. In other words, the output unit of the electronic apparatus 1 generates a video output, which is an image of the electronic document 31. If the touch input module 103 detects a movement of an object, the touch input module 103 generates a corresponding input signal 102. In other words, one input unit of the electronic apparatus 1 generates an input signal according to an object. Thereafter, the touch input module 103 transmits the input signal 102 to the processor 101. When the processor 101 receives the input signal 102, the video signal 100 is adjusted according to the input signal 102. The image of the electronic document 31 is moved on the display module 107 toward the indicated direction of the touch movement. For example, if the touch input module 103 detects a sliding-up touch, the display module 107 displays a lower portion of the electronic document 31, as shown in FIG. 4. The object in this embodiment is a finger of the user, but the object in the present invention is not limited by the embodiment. The object can be any operating tools.

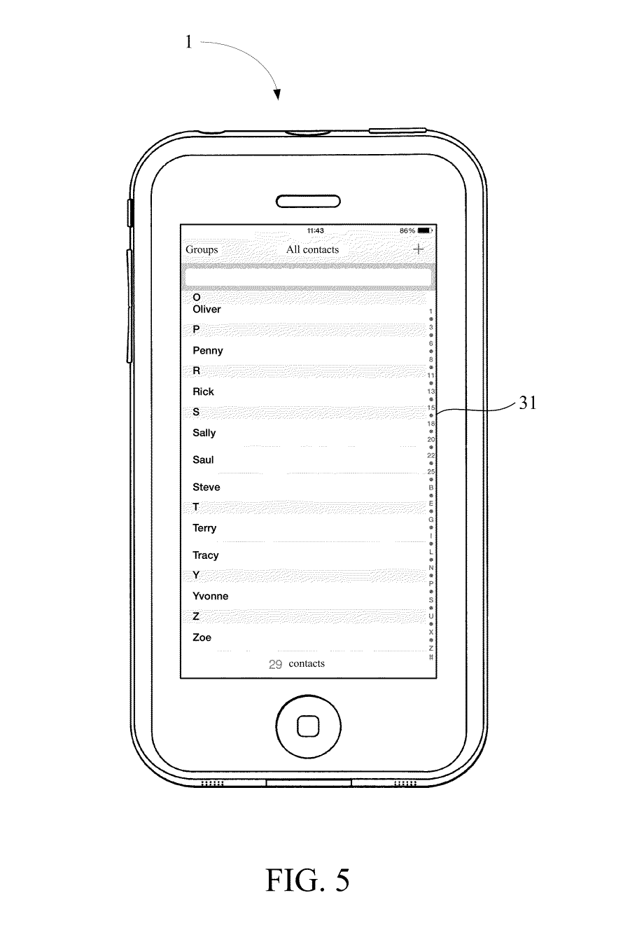

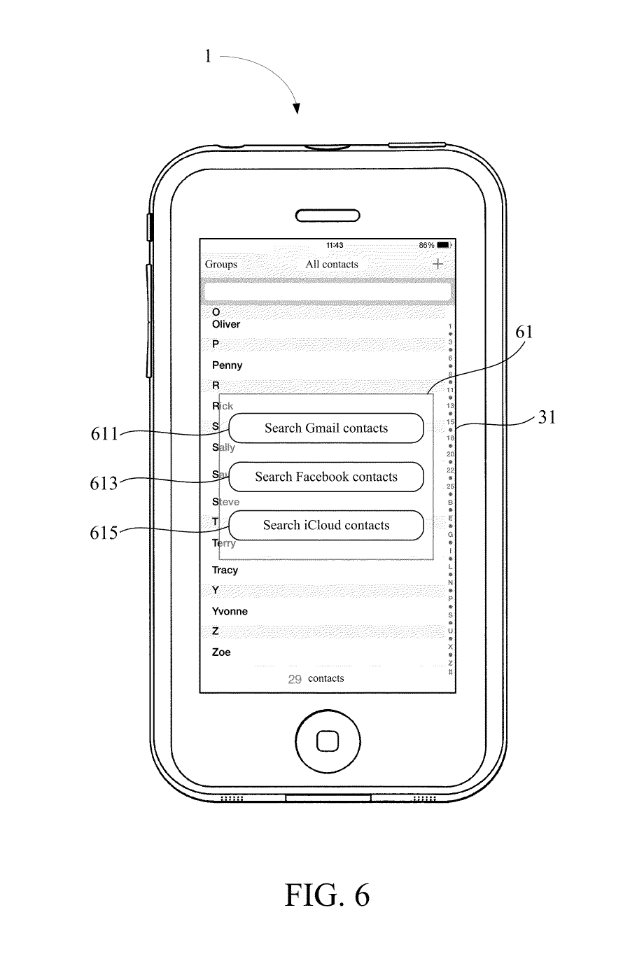

As shown in FIG. 5, the image of the electronic document 31 may be accordingly moved until an edge of the electronic document 31 is shown. That is to say, the processor 101 of the electronic apparatus 1 adjusts the output of the output to a predetermined state according to the input signal 102. When the predetermined state is reached, the processor 101 identifies if the touch input module 103 receives the same input signal 102 again. When the image of the electronic document 31 is accordingly moved until an edge of the electronic document 31 is shown, and the processor 101 receives the same input signal 102 from the touch input module 103 again, the processor 101 enables a predetermined operation mode of the electronic apparatus 1. As shown in FIG. 6, the processor 101 enables the display module 107 to display an operation menu 61.

The operation menu 61 includes three operation options 611, 613, 615 in this embodiment. The operation option 611 is an option to search Gmail contacts, the operation option 613 is an option to search Facebook contacts, and the operation option 615 is an option to search iCloud contacts. The number and the usages of the operation options are not limited to this embodiment. As a result, user can intuitively, clearly, accurately and easily chooses the needed option.

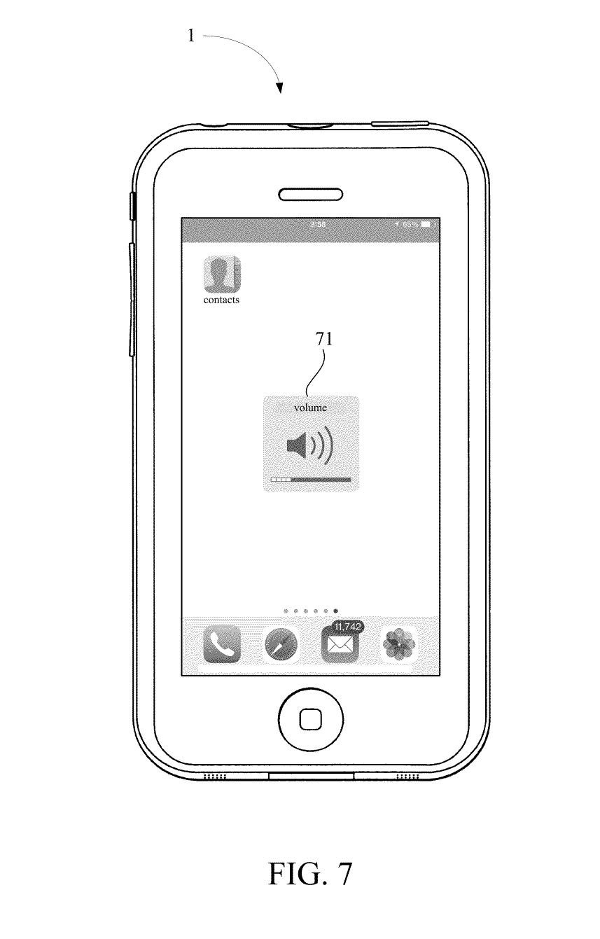

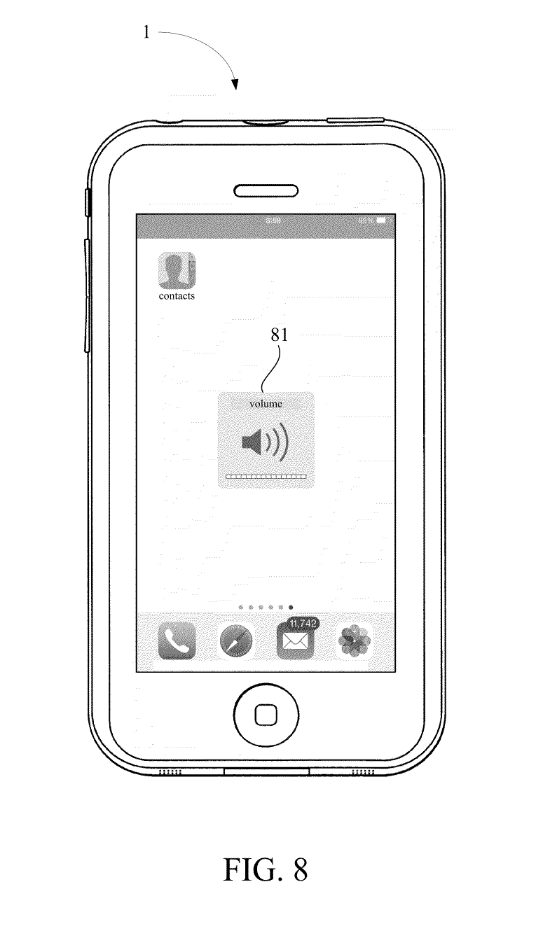

Referring to FIG. 1, FIG. 2, FIG. 7 and FIG. 8, another operation mode enabling method of the electronic apparatus 1 is provided. In operation of the electronic apparatus 1, the processor 101 transmits an audio signal 104 to the sound module 109, such that the sound module 109 plays a sound. In other words, the output unit of the electronic apparatus 1 generates an audio output. If the volume adjustment module 105 detects a movement of an object, the volume adjustment module 105 generates a corresponding input signal 106. In other words, one input unit of the electronic apparatus 1 generates an input signal according to an object. Thereafter, the volume adjustment module 105 transmits the input signal 106 to the processor 101. When the processor 101 receives the input signal 106, the audio signal 104 is adjusted according to the input signal 106. The volume of the sound is turned up or down. On the other hand, the processor 101 also adjusts the video signal 100 according to the input signal 106. The display module 107 displays a volume adjustment box 71 as sown in FIG. 7. That is to say, the processor 101 adjusts both the audio signal 104 and the video signal 100 according to the input signal 106 in this embodiment. The object in this embodiment is a finger of the user, but the object in the disclosure is not limited by the embodiment.

As shown in FIG. 8, the volume of the sound module 109 may be further adjusted to a limit of the volume. The display module 107 is adjusted to display a volume adjustment box 81 of the limit of the volume. Namely, the processor 101 of the electronic apparatus 1 adjusts the output of the output unit to a predetermined state according to the input signal 106. When the predetermined state is reached, the processor 101 identifies if the volume adjustment module 105 receives the same input signal 106 again. When the volume reaches the limit, and the processor 101 receives the same input signal 106 from the volume adjustment module 105 again, the processor 101 enables a predetermined operation mode in the electronic apparatus 1. In this embodiment, the processor 101 enables the sound module 109 to perform an active noise control (ANC) mode.

The ANC mode in this embodiment enable the sound module 109 to display a clearer audio output, but the predetermined operation mode is not limited by the ANC mode. In another embodiment, the aforementioned operations can be done in a call, and the predetermined operation mode may be an automatic message. When the volume reaches the limit, and the processor 101 receives the same input signal 106 from the volume adjustment module 105 again, the processor 101 enables the processor 101 to cut off the call and automatically sends a message 108 by the transceiver 111.

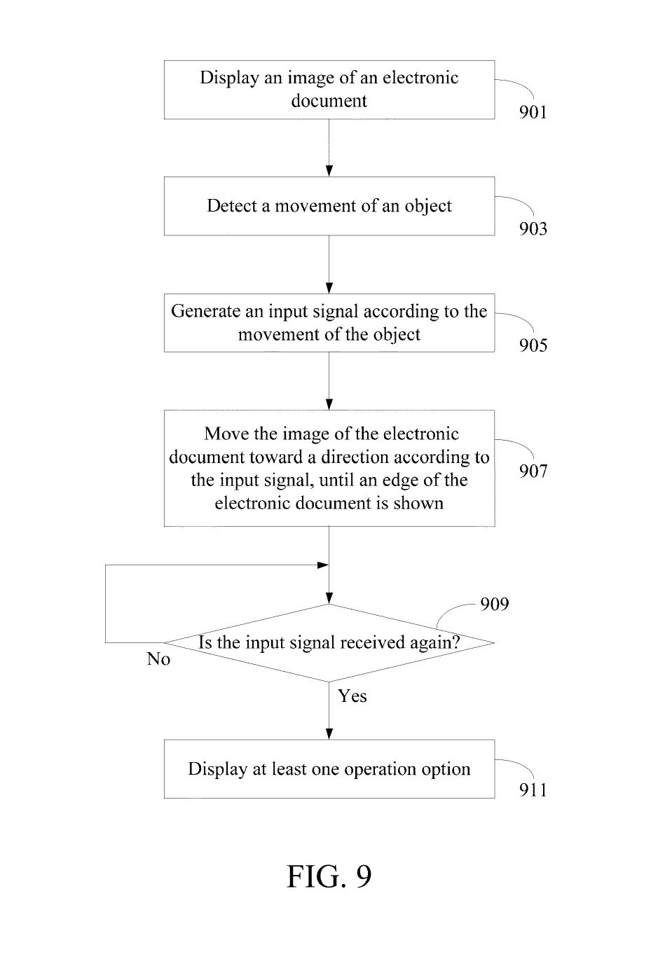

Referring to FIG. 9, a flow chart of an operation mode enabling method according to the second embodiment is shown. The operation mode enabling method can be applied to any electronic apparatus of the present invention, such as the electronic apparatus 1 in the first embodiment. The electronic apparatus includes a processor, a touch input module and a display module. The processor is electrically connected to the touch input module and the display module.

The operation mode enabling method in the second embodiment includes the following steps. First, the display module displays an image of an electronic document in the step 901. In other words, an output unit generates an output. In the step 903, the touch input module detects at least one movement of an object. In the step 905, the touch input module generates at least one input signal according to the movement of the object. In other words, an input unit generates at least one input signal according to an object. In the step 907, the processor moves the image of the electronic document toward a direction according to the input signal, until an edge of the electronic document is shown. When the predetermined state is reached, the step 909 is performed to identify if the touch input module receives the input signal again by the processor.

If the touch input module does not receive the same input signal in the predetermined state, the step 909 is performed again. Otherwise, if the touch input module receives the same input signal in the predetermined state, the display module displays at least one operation option in the step 911. Namely, the processor generates an enable signal by the processor for enabling a predetermined operation mode in the electronic apparatus.

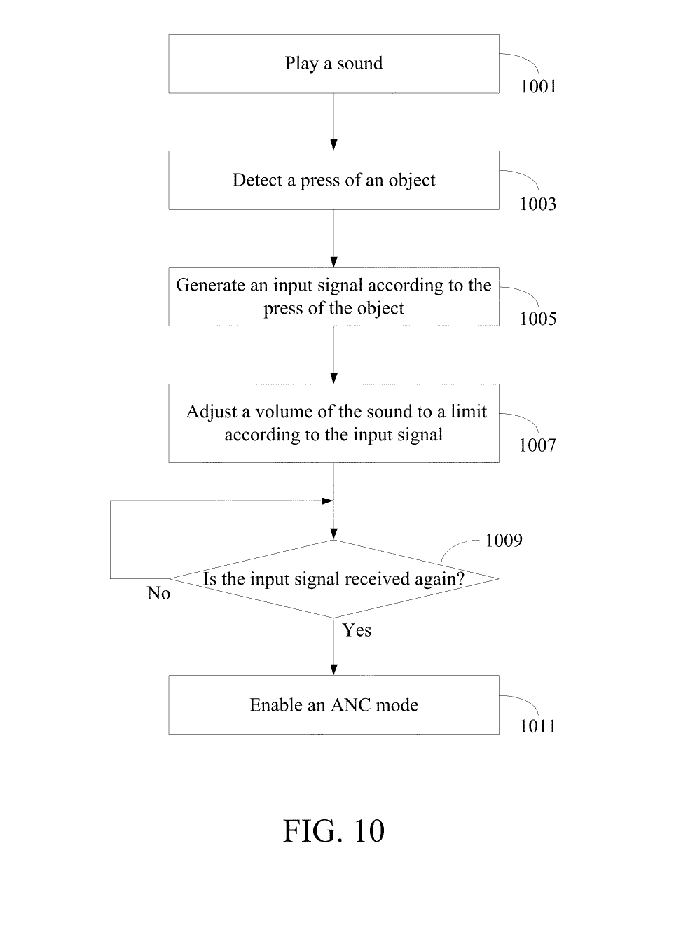

Referring to FIG. 10, a flow chart of an operation mode enabling method according to the third embodiment is shown. The operation mode enabling method can be applied to any electronic apparatus of the present invention, such as the electronic apparatus 1 in the first embodiment. The electronic apparatus includes a processor, a touch input module and a display module. The processor is electrically connected to the touch input module and the display module.

The operation mode enabling method in the third embodiment includes the following steps. First, the sound module plays a sound in the step 1001. In other words, an output unit generates an output. In the step 1003, the volume adjustment module detects at least one press of an object. In the step 1005, the volume adjustment module generates at least one input signal according to the press of the object. In other words, an input unit generates at least one input signal according to an object. In the step 1007, the processor receives the input signal, and adjusts a volume of the audio output into a predetermined state according to the at least one input signal. In this embodiment, the predetermined state is a limit of the volume. When the predetermined state is reached, the step 1009 is performed to identify if the volume adjustment module receives the input signal again by the processor.

If the processor does not receive the same input signal in the predetermined state, the step 1009 is performed again. Otherwise, if the processor receives the same input signal in the predetermined state, the display module displays at least one operation option in the step 1011. Namely, the processor generates an enable signal by the processor for enabling a predetermined operation mode in the electronic apparatus. The processor enables an ANC mode. In other words, the processor generates an enable signal by the processor for enabling a predetermined operation mode in the electronic apparatus.

In addition to the aforesaid steps, the second and the third embodiments can also execute all the operations and functions set forth in the first embodiment. How the object information search method for an electronic apparatus of the present invention executes these operations and functions will be readily appreciated by those of ordinary skill in the art based on the explanation of the first embodiment and, thus, will not be further described herein.

Specifically speaking, the operation mode enabling methods in the second and the third embodiments can be performed by a computer program product. After the electronic apparatus loads and executes the computer program product, the operation mode enabling method in the second and the third embodiments can be accomplished. The computer program product may be stored in a computer readable recording medium, such as a read-only memory (ROM), a flash memory, a floppy disk, a hard disk, a CD, a flash drives, a magnetic tape, an internet database or any other suitable storage media with the same function and well known to those skilled in the art.

As mentioned above, once the processor receives the said input signal again in the predetermined state, the disclosed electronic apparatus and the related method could enable a predetermined operation mode in the electronic apparatus. Thus, the above deficiencies and other problems associated with the complicated key sequences and menu hierarchies for portable devices are reduced or eliminated by the disclosed electronic apparatus. The displayed information can be distinguished accurately, and users are not overloaded with extraneous information.

Furthermore, the electronic apparatus and the related method of the present invention could enable enables the sound module 109 to display an active noise control (ANC) mode, which enables the sound module 109 to display a clearer audio output.

The above embodiments merely give the detailed technical contents of the present invention and inventive features thereof, and are not to limit the covered range of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An operation mode enabling method of an electronic apparatus, the electronic apparatus comprising an input unit, a processor and an output unit, the operation mode enabling method comprising the following steps of:
generating an output by the output unit;
generating at least one input signal by the input unit according to an object;
receiving the at least one input signal by the processor;
adjusting the output of the output unit to a predetermined state according to the at least one input signal;
identifying if the processor receives the at least one input signal again in the predetermined state by the processor; and
enabling a predetermined operation mode of the electronic apparatus by the processor when the processor receives the at least one input signal again in the predetermined state.

2. The operation mode enabling method of claim 1, wherein the output unit of the electronic apparatus is a display module, and the output is an image of an electronic document.

3. The operation mode enabling method of claim 2, wherein the input unit of the electronic apparatus is a touch input module, and the step of generating at least one input signal by the input unit further comprises the following steps of:
detecting at least one movement of the object by the touch input module; and
generating the at least one input signal by the touch input module according to the at least one movement of the object.

4. The operation mode enabling method of claim 3, wherein the step of adjusting the output to the predetermined state further comprises the following step of:
moving the image of the electronic document toward a direction according to the at least one input signal received by the processor;
wherein the predetermined state is an image of an edge of the electronic document.

5. The operation mode enabling method of claim 2, wherein the step of enabling the predetermined operation mode further comprises the following step of:
displaying at least one operation option by the display module in the predetermined operation mode.

6. The operation mode enabling method of claim 1, wherein the output unit of the electronic apparatus is a sound module, and the output is an audio output.

7. The operation mode enabling method of claim 6, wherein the input unit of the electronic apparatus is a volume adjustment module, and the step of generating at least one input signal by the input unit comprises the following steps of:
detecting at least one press of the object by the volume adjustment module; and
generating the at least one input signal by the volume adjustment module according to the at least one press of the object.

8. The operation mode enabling method of claim 7, wherein the step of adjusting the output to the predetermined state by the processor further comprises the following step of:
adjusting a volume of the audio output according to the at least one input signal received by the processor;
wherein the predetermined state is a limit of the volume.

9. The operation mode enabling method of claim 6, wherein the predetermined operation mode of the electronic apparatus is an active noise control (ANC) mode.

10. An electronic apparatus, comprising:
an output unit for generating an output;
an input unit for generating at least one input signal according to an object; and
a processor, electrically connected to the output unit and the input unit, for receiving the at least one input signal and adjusting the output of the output unit to a predetermined state according to the at least one input signal;
wherein the processor enables a predetermined operation mode of the electronic apparatus when receiving the at least one input signal again in the predetermined state.

11. The electronic apparatus of claim 10, wherein the output unit is a display module, and the output is an image of an electronic document.

12. The electronic apparatus of claim 11, wherein the input unit is a touch input module for generating the at least one input signal according to at least one movement of the object.

13. The electronic apparatus of claim 12, wherein the processor moves the image of the electronic document toward a direction according to the at least one input signal, and the predetermined state is an image of an edge of the electronic document.

14. The electronic apparatus of claim 11, wherein the display module displays at least one operation option in the predetermined operation mode.

15. The electronic apparatus of claim 10, wherein the output unit is a sound module for generating an audio output.

16. The electronic apparatus of claim 15, wherein the input unit is a volume adjustment module for detecting at least one press of the object, and the volume adjustment module generates the at least one input signal according to the at least one press of the object.

17. The electronic apparatus of claim 16, wherein the processor adjusts a volume of the audio output according to the at least one input signal, and the predetermined state is a limit of the volume.

18. The electronic apparatus of claim 15, wherein the predetermined operation mode of the electronic apparatus is an active noise control mode.
